(19) United States
(12) Patent Application Publication
(10) Pub. No.: US 2024/0306855 A1
(43) Pub. Date: Sep. 19, 2024

(54) HEIGHT ADJUSTABLE BATHTUB

(71) Applicant: Clovia Melissa McIntosh, West Haven, CT (US)

(72) Inventor: Clovia Melissa McIntosh, West Haven, CT (US)

(21) Appl. No.: 18/575,965

(22) PCT Filed: Jun. 30, 2022
(86) PCT No.: PCT/US22/35659

§ 371 Date: Jan. 2, 2024

Related U.S. Application Data
(60) Provisional application No. 63/216,567, filed on Jun. 30, 2021.

(51) Int. Cl. A47K 3/064; A47K 3/164

(52) U.S. Cl. CPC A47K 3/064; A47K 3/164

(57) ABSTRACT

A height adjustable bathtub includes a housing that extends from a first longitudinal end to a second longitudinal end and that extends from a first lateral end to a second lateral end. The housing has an interior wall that defines a cavity therein. An expandable basin is positioned within the cavity and is secured to the interior wall of the housing. An extendable base is secured to a bottom surface of the housing. The expandable basin includes a perimeter wall and a floor. The perimeter wall includes an upper wall portion that is secured to the interior wall of the housing, a bottom wall portion that is integrally formed with the floor, and a flexible intermediate wall portion that is secured to the upper wall portion and the bottom wall portion.

### CROSS REFERENCE TO RELATED APPLICATION(S)

This application claims the priority benefit of U.S. Provisional Patent Application No. 63/216,567, filed Jun. 30, 2021, which is incorporated by reference as if disclosed herein in its entirety.

### FIELD

The present technology relates to a bathtub that serves as a reinforcement for children as they bathe. More particularly, the present technology relates to an expandable washbasin that height adjustable to alleviate the pressure off the parents' or guardians' back.

### BACKGROUND

Infants are generally cleaned by bathing. Bathing is often characterized as fun, but care is recommended when an infant is in or around water. Most child drowning deaths happen at home, often when a child is alone while bathing. Traditionally, child bathtubs require the child to be lying or sitting down in the tub. These tubs also lack traction such that a child standing in the tub is likely to fall and sustain injury.

Approximately 120 children in the United States are sent to the emergency room daily. Most of these injuries occur in children 4 years old and under. The most affected body region is the head, accounting for nearly 50% of bath injuries. Adult supervision is not enough because these injuries happen so quickly that parents often cannot react quick enough.

The baby care products market is projected to be worth approximately $109.13 billion worldwide by 2026, which is a substantial increase from the estimated value of the market in 2018 of $73.86 billion. The global baby product market size was valued at $10.91 billion in 2017 and is expected to register a CAGR of 5.5% over the forecast period on account of rising spending capability and changing lifestyles. Rapid urbanization and growing middle-class population across several developing regions are further driving the market. Changing lifestyle, particularly in developing countries, has encouraged the adoption of convenience-oriented routine, making these items desirable, which will fuel the industry growth over the forecast period. Even though majority of baby bathtubs are for newborns there is an entire market available for baby care products.

What is needed, therefore, is an improved bathtub that addresses at least the problems described above.

### SUMMARY

According to an embodiment of the present technology, a height adjustable bathtub is provided. The height adjustable bathtub includes a housing that extends from a first longitudinal end to a second longitudinal end and that extends from a first lateral end to a second lateral end. The housing has an interior wall that defines a cavity therein. An expandable basin is positioned within the cavity and is secured to the interior wall of the housing. An extendable base is secured to a bottom surface of the housing.

In some embodiments, the expandable basin includes a perimeter wall and a floor. The perimeter wall includes an upper wall portion that is secured to the interior wall of the housing, a bottom wall portion that is integrally formed with the floor, and a flexible intermediate wall portion that is secured to the upper wall portion and the bottom wall portion.

In some embodiments, the floor includes a drainage hole therein and a removable plug is positioned in the drainage hole.

In some embodiments, the extendable base includes an inner member that slidingly engages an outer member. The inner member is configured to lock at a plurality of positions within the outer member.

In some embodiments, the inner member has a pin that is configured to engage one of a plurality of locking slots of the outer member to lock the extendable base at a desired length.

In some embodiments, the extendable base includes at least one extendable leg.

In some embodiments, the at least one extendable leg is configured to pivot about a connection point on the bottom surface of the housing such that the at least one extendable leg is movable between an active position and a storage position.

In some embodiments, the at least one extendable leg includes an inner member that slidingly engages an outer member. The inner member has a pin that is configured to engage one of a plurality of locking slots of the outer member to lock the extendable leg at a desired length.

In some embodiments, the housing includes an opening therein that is positioned between the interior wall and the first longitudinal end. In some embodiments, a pocket is positioned within the opening and is secured to the housing.

In some embodiments, a handlebar is attached to the housing. The handlebar has a first end attached to the first lateral end of the housing and a second end attached to the second lateral end of the housing. In some embodiments, each of the first end and the second end of the handlebar includes a clip that is configured to snap-fit over a perimeter lip of the housing such that the handlebar is slidable along a length of the housing.

According to another embodiment of the present technology, an expandable washbasin is provided. The expandable washbasin includes a floor and a perimeter wall. The perimeter wall includes a first end wall portion, a second end wall portion, and an expandable intermediate wall portion that is positioned between and secured to the first end wall portion and the second end wall portion.

In some embodiments, a drainage hole is in the floor and a removable plug is positioned in the drainage hole.

In some embodiments, the expandable intermediate wall portion is formed of a flexible material.

In some embodiments, the second end wall portion is integrally formed with the floor.

In some embodiments, the perimeter wall is positioned within a cavity of a housing and the first end wall portion is secured to an interior wall of the housing defining the cavity.

In some embodiments, an extendable base is secured to a bottom surface of the housing.

In some embodiments, the extendable base includes an inner member that slidingly engages an outer member. The inner member is configured to lock at a plurality of positions within the outer member.

In some embodiments, the inner member has a pin that is configured to engage one of a plurality of locking slots of the outer member to lock the extendable base at a desired length.

In some embodiments, the extendable base includes at least one extendable leg.

In some embodiments, the at least one extendable leg is configured to pivot about a connection point on the bottom surface of the housing such that the at least one extendable leg is movable between an active position and a storage position.

In some embodiments, the at least one extendable leg includes an inner member that slidingly engages an outer member. The inner member has a pin that is configured to engage one of a plurality of locking slots of the outer member to lock the extendable leg at a desired length.

In some embodiments, an opening is in the housing and is positioned adjacent the interior wall. In some embodiments, a pocket is positioned within the opening and is secured to the housing.

In some embodiments, the expandable intermediate wall portion includes a front wall portion and a rear wall portion. Each of the front wall portion and the rear wall portion includes at least two panels connected via a first hinge. A first of the at least two panels is connected to the first end wall portion via a second hinge and a second of the at least two panels is connected to the second end wall portion via a third hinge.

In some embodiments, the rear wall portion has a height that is greater than a height of the front wall portion.

In some embodiments, at least one pocket is secured to an interior surface of the rear wall portion.

In some embodiments, the floor is formed of a flexible material.

In some embodiments, each of the first end wall portion and the second end wall portion includes an opening passing therethrough and that is positioned adjacent a top end thereof.

In some embodiments, the top end of the first and second end wall portions and an upper section of the opening have corresponding ergonomically shaped contours.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is an isometric view of a height adjustable bathtub according to an exemplary embodiment of the present technology.

FIG. 2 is a side view of the height adjustable bathtub of FIG. 1.

FIG. 3 is a side elevational view of a height adjustable bathtub according to an exemplary embodiment of the present technology positioned at a first usable height.

FIG. 4 is a side elevation view of the height adjustable bathtub of FIG. 3 positioned at a second usable height.

FIG. 5 is an isometric view of the height adjustable bathtub of FIG. 1 shown in a storage position.

FIG. 6 is an isometric view of a standing bathtub according to an exemplary embodiment of the present technology.

FIG. 7 is an isometric view of the standing bathtub of FIG. 6 shown in a storage position.

FIG. 8 is an enlarged top view showing the floor of the standing bathtub of FIG. 6.

FIG. 9 is an enlarged isometric view showing the rear wall portion and pockets of the standing bathtub of FIG. 6.

### DETAILED DESCRIPTION

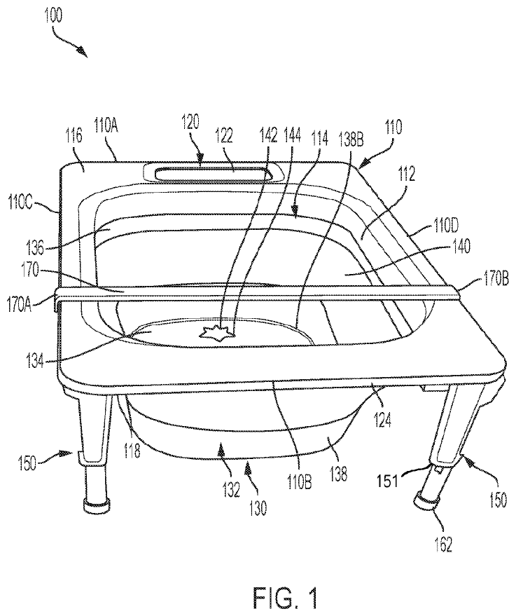

As shown in FIG. 1, a height adjustable bathtub is generally designated by the numeral 100. The height adjustable bathtub 100 includes a housing 110 that extends from a first longitudinal end 110A to a second longitudinal end 110B and that extends from a first lateral end 110C to a second lateral end 110D. In the embodiment shown in the figures, the housing 110 has a generally rectangular shape, but the present technology is not limited thereto and contemplates embodiments where the housing 110 has different shapes, such as circular, ellipsoidal, hexagonal, etc. The housing 110 has a cavity 114 therein defined by an interior wall 112. In some embodiments, the cavity 114 is centrally located between the first longitudinal end 110A and the second longitudinal end 110B and/or centrally located between the first lateral end 110C and the second lateral end 110D. In some embodiments, the housing 100 is formed of a plastic material, such as high density polyethylene (“HDPE”).

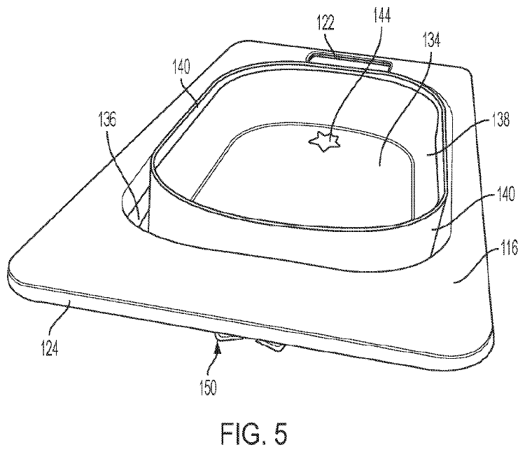

As shown in FIG. 1, the height adjustable bathtub 100 includes an expandable basin (e.g., a washbasin) 130 that is positioned within the cavity 114 of the housing 110. In some embodiments, the expandable basin 130 is secured to the interior wall 112 of the housing 110. In some embodiments, the expandable basin 130 is integrally formed with the interior wall 112 of the housing 110. The expandable basin 130 includes a perimeter wall 132 and a floor 134. The perimeter wall 132 includes an upper wall portion 136, a bottom wall portion 138, and a flexible intermediate wall portion 140. The upper wall portion 136 is secured to the interior wall 112 of the housing 110. The bottom wall portion 138 is secured to the floor 134. In some embodiments, the bottom wall portion 138 is integrally formed with the floor 134. The flexible intermediate wall portion 140 is positioned between and secured to the upper wall portion 136 and the bottom wall portion 138. As shown in FIGS. 1 and 5, the floor 134 has a drainage hole 142 therein. In some embodiments, a removable plug 144 is received in the drainage hole 142 such that the expandable basin 130 is configured to retain and later drain a liquid (e.g. water) as desired by a user via operation of the plug 144 and drainage hole 142. In some embodiments, the plug 144 is connected to an emergency release button to quickly drain the expandable basin 130 in case of emergency.

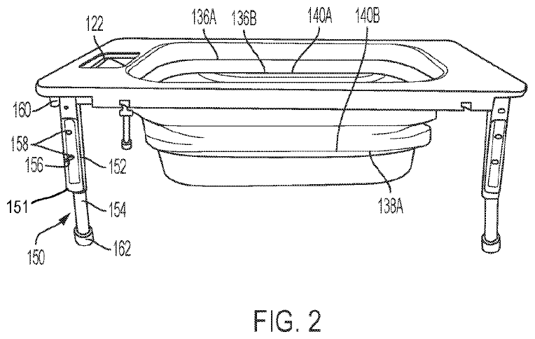

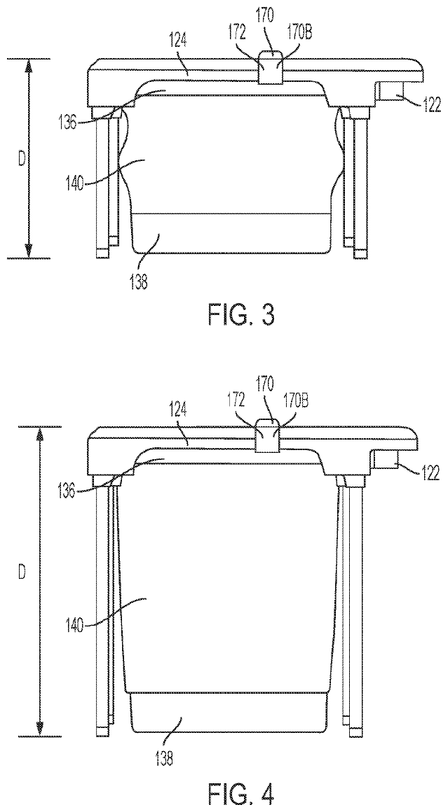

As shown in FIGS. 1-2, a top edge 136A of the upper wall portion 136 is secured to the interior wall 112 of the housing 110, a bottom edge 136B of the upper wall portion 136 is secured to a top edge 140A of the flexible intermediate wall portion 140, a top edge 138A of the bottom wall portion 138 is secured to a bottom edge 140B of the flexible intermediate wall portion 140, and a bottom edge 138B of the bottom wall portion 138 is secured to the floor 134. The flexible intermediate wall portion 140 is configured to change shape (e.g., bend, fold, stretch, compress, etc.) as the upper wall portion 136 and the bottom wall portion 138 are moved toward or away from each other such that a depth D of the expandable basin 130 is adjustable based on the distance between the upper wall portion 136 and the bottom wall portion 138, as shown in FIGS. 3-4. In some embodiments, the flexible intermediate wall portion 140 is formed of a silicone material. In some embodiments, the upper wall portion 136, the bottom wall portion 138, and the floor 134 are formed of a plastic material, such as HDPE.

As shown in FIGS. 1-2, the height adjustable bathtub 100 includes an extendable base 150 that is secured to a bottom surface 118 of the housing 110. In some embodiments, the extendable base 150 includes at least one extendable leg 151. In the embodiment shown in the figures, the extendable base 150 includes four extendable legs 151, but the present technology is not limited thereto and contemplates embodiments where the extendable base 150 includes any number of extendable legs 151. In some embodiments, each extendable leg 151 has a telescoping structure with an inner member 152 that is in sliding engagement with an outer member 154. In some embodiments, the inner member 152 has a pin 156 on an outer surface thereof that is configured to engage one of a plurality of slots 158 in the outer member 154 such that a user can manually lock the extendable leg 151 at one of a plurality of lengths. In some embodiments, the pin 156 is a pushpin that is configured to be pushed through the plurality of slots 158 (e.g., holes). In some embodiments, the pin 156 is integrally formed with the inner member 152 and each of the plurality of slots 158 includes at least two angled segments (such that the slot 158 has, e.g., an inverted “L” shape) such that the extendable leg 151 is lockable via pushing and rotating (e.g., twisting) the inner member 152 within the outer member 154. In some embodiments, the extendable leg 151 is automatically adjusted between and locked at a plurality of lengths via an internal hydraulic or pneumatic mechanism, a twist and release mechanism, etc. Thus, as the extendable base 150 increases in length, the height of the housing 110 increases and the upper wall portion 136 is pulled apart from the bottom wall portion 138 to increase the depth D of the expandable basin 130, as shown in FIGS. 3-4.

In some embodiments, the extendable leg 151 is secured to the bottom surface 118 of the housing 110 via a pivot pin 160 such that the extendable leg 151 is movable (e.g., pivotable or rotatable) between an active position and a storage position, as shown in FIGS. 2 and 5. When the height adjustable bathtub 100 is in the storage position shown in FIG. 5, the flexible intermediate wall portion 140 folds over and downward such that the upper wall portion 136 is positioned below the bottom wall portion 138. In some embodiments, the extendable leg 151 includes a frictional base member 162 (e.g., a rubber foot pad or sleeve) at the bottom thereof to resist sliding and increase stability of the height adjustable bathtub 100 during use.

As shown in FIG. 1, the housing 110 includes an opening 120 that is positioned between the interior wall 112 and the first longitudinal end 110A. However, the present technology is not limited in this regard and contemplates embodiments where the opening 120 is positioned between the interior wall 112 and the second longitudinal end 110B, the first lateral end 110C, or the second lateral end 110D. A pocket 122 is positioned within the opening 120 and is secured to the housing 110. The pocket 122 is configured to receive bathing accessories, such as soap, shampoo, combs, toys, etc., when the height adjustable bathtub 100 is in use. The opening 120 and/or pocket 122 provide a handhold for maneuvering the height adjustable bathtub 100 and are configured to engage a hanging means (e.g., a mounted hook) for storing the height adjustable bathtub 100 when not in use. In some embodiments, the pocket 122 is formed of a silicone material.

As shown in FIG. 1, the height adjustable bathtub 100 includes a handlebar 170 that has a first end 170A that is attached to the first lateral end 110C of the housing 110 and a second end 170B that is attached to the second lateral end 110D of the housing 110. The housing 110 has a perimeter lip 124 that extends from a top surface 116 toward and past the bottom surface 118. The first end 170A and the second end 170B of the handlebar 170 each include a clip 172 that is configured to snap-fit over the perimeter lip 124 of the housing 110. In some embodiments, the handlebar 170 is configured to slide along the length of the housing 110 as measured between the first longitudinal end 110A and the second longitudinal end 110B. The handlebar 170 is useable for hanging toys and sensory items to occupy/entertain a child within the expandable basin 130.

In some embodiments, the height adjustable bathtub 100 includes at least one of the following accessory features discussed herein. In some embodiments, the expandable basin 130 is formed of a material that is configured to change color based on temperature. In some embodiments, a thermometer is installed within the perimeter wall 132 and is visible via a window or opening. In some embodiments, a temperature sensor generates a temperature signal that is indicative of the temperature of a liquid within the expandable basin 130 and transmits the temperature signal to a computing device that is configured to convert the temperature signal into an audio signal and emit the audio signal via a speaker such that the temperature of the liquid is read aloud to a user. In some embodiments, a gyroscope (or any other level sensing device) is installed within the housing 100 that generates a distress signal indicative of the housing 100 being un-leveled in at least one dimensional plane and transmits the distress signal to a computing device that is configured to convert the distress signal into an audio alarm signal and emit the audio alarm signal via a speaker to alert a user that the housing 100 is off-balance and that an occupant may be in distress (e.g., the bathtub may be tipping over and a child in the bathtub is potentially in danger). In some embodiments, the floor 134 includes a scale or any other pressure/force sensor configured to measure the weight of an occupant in the expandable basin 130. In some embodiments, the expandable basin 130 includes a seat (integrally formed or detachable) and/or a safety harness. In some embodiments, a wave maker is installed within the expandable basin 130. In some embodiments, the expandable basin 130 includes a jet pump and/or a motor configured to form bubbles in a liquid in the expandable basin 130 and/or heat the liquid. In some embodiments, at least one automatic dispenser is installed in the housing 100 for dispensing soap, shampoo, conditioner, etc. for a user. In some embodiments, a lighting system is installed on the perimeter wall 132 and/or the floor 134. In some embodiments, the expandable basin 130 includes an automatic self-cleaning system. In some embodiments, the height adjustable bathtub 100 is configured to be folded (e.g., folded in half, folded in quarters, flip to fold, etc.) for more compact storage.

Although embodiments of the present technology are generally directed towards a height adjustable bathtub 100 for a baby/toddler/child, the present technology is not limited thereto and contemplates embodiments where the height adjustable bathtub 100 is configured for bathing pets. In such embodiments, the height adjustable bathtub 100 includes at least one of the accessory features discussed below and/or above. In some embodiments, the expandable basin 130 includes a jet pump and/or a motor configured to dispense water from the perimeter wall 132 and/or the floor 134. In some embodiments, the expandable basin 130 includes an animal harness. In some embodiments, the expandable basin 130 includes an air pump and/or a motor configured to blow heated air from the perimeter wall 132 to blow-dry an animal within the expandable basin 130. In some embodiments, the floor 134 includes a soap pad configured to dispense soap in response to pressure from an animal's weight/steps on the soap pad within the expandable basin 130.

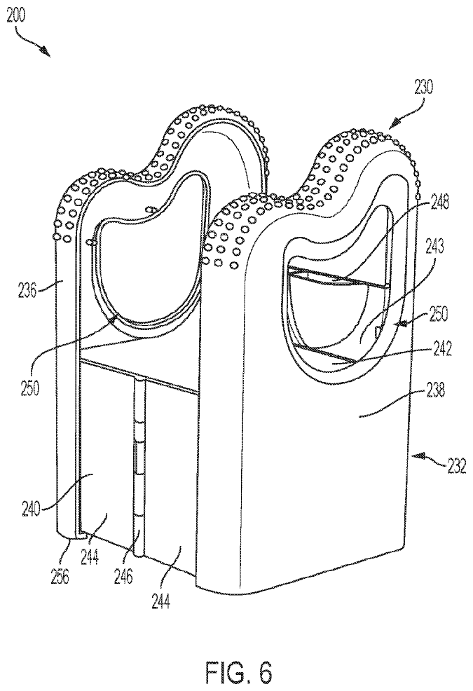

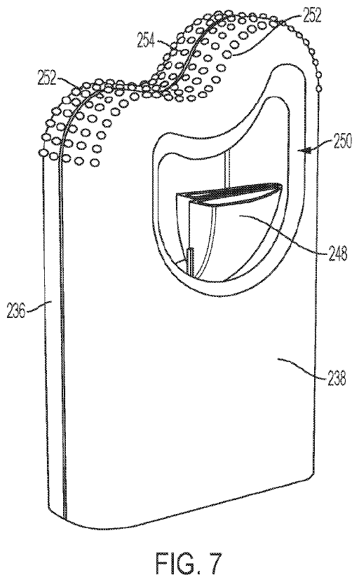

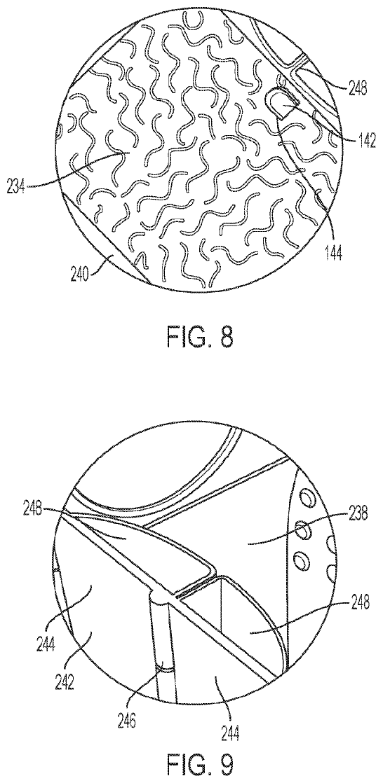

As shown in FIG. 6, a standing bathtub is generally designated by the numeral 200. The standing bathtub 200 includes an expandable basin (e.g., a washbasin) 230 having a perimeter wall 232 and a floor 234. The perimeter wall 232 includes a first side wall portion 236, a second side wall portion 238, and an expandable front wall portion 240 and an expandable rear wall portion 242 each connected to the first side wall portion 236 and the second side wall portion 238. Each of the expandable front wall portion 240 and the expandable rear wall portion 242 includes at least two panels 244 that are connected to each other via a first hinge 246. A first of the at least two panels 244 is connected to the first side wall portion 236 via a second hinge 246 and a second of the at least two panels 244 is connected to the second side wall portion 238 via a third hinge 246. Thus, by operation of the panels 244 and the hinges 246, the expandable front wall portion 240 and the expandable rear wall portion 242 fold or unfold to move the standing bathtub 200 between active and storage positions, as shown in FIGS. 6-7. In some embodiments, the expandable front wall portion 240 and the expandable rear wall portion 242 are configured to lock (via e.g., a latch) in the active position when in use and in the storage position for ease of storage and transport. In some embodiments, the perimeter wall 232 is formed of a plastic material, such as HDPE. The floor 234 is flexible such that it folds or unfolds along with the expandable front wall portion 240 and the expandable rear wall portion 242. As shown in FIG. 8, in some embodiments, the floor 234 has the drainage hole 142 and removable plug 144 therein as discussed above regarding the adjustable height bathtub 100. In some embodiments, the floor 234 is formed of a slip-resistant material, such as silicone.

In some embodiments, the expandable rear wall portion 242 has a height that is greater than a height of the expandable front wall portion 240, as shown in FIG. 6. In some embodiments, the expandable rear wall portion 242 has at least one pocket 248 secured to an interior surface 243 thereof. In some embodiments, each panel 244 has a pocket 248 secured thereto adjacent the hinge 246 adjoining the panels 244, as shown in FIG. 9. The pocket 248 is configured to receive bathing accessories, such as soap, shampoo, combs, toys, etc., when the standing bathtub 200 is in use. In some embodiments, the pocket 248 is formed of a silicone material.

As shown in FIGS. 6-7, each of the first side wall portion 236 and the second side wall portion 238 have a handle opening 250 passing therethrough and positioned adjacent a contoured top 252 thereof. The contoured top 252 has an ergonomically shaped contour and an upper section 250A of the opening 250 has an ergonomically shaped contour that corresponds to the ergonomically shaped contour of the contoured top 252 to provide a handhold for maneuvering the standing bathtub 200. In some embodiments, each contoured top 252 includes a plurality of frictional raised members (e.g., hand grips) 254 thereon.

In some embodiments, each of the first side wall portion 236 and the second side wall portion 238 include an extendable base 256 such that the standing bathtub 200 is height adjustable. In some embodiments, the extendable base 256 includes the telescoping structure (e.g., manual, hydraulic, pneumatic, etc.) discussed above regarding the extendable legs 151 of the height adjustable bathtub 100. In some embodiments, the floor 234 is height adjustable via waterproof hydraulics that utilizes a pressure release valve. In some embodiments, the floor 234 includes a lever system configured to manual height adjustments. In some embodiments, the standing bathtub 200 includes at least one of the accessory features discussed above regarding the child and animal embodiments of the height adjustable bathtub 100.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

The terms “longitudinal” and “lateral” as used herein are for naming purposes and are for the convenience of understanding the direction and location of certain elements described herein. The terms “longitudinal” and “lateral” are not meant to be limiting to any one orientation of the technology or element or feature of the technology.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1. A height adjustable bathtub comprising:
a housing extending from a first longitudinal end to a second longitudinal end and extending from a first lateral end to a second lateral end, the housing having an interior wall defining a cavity therein;
an expandable basin positioned within the cavity and secured to the interior wall of the housing; and
an extendable base secured to a bottom surface of the housing.

2. The height adjustable bathtub of claim 1, wherein the expandable basin comprises a perimeter wall and a floor, the perimeter wall comprising:
an upper wall portion secured to the interior wall of the housing;
a bottom wall portion integrally formed with the floor; and
a flexible intermediate wall portion secured to the upper wall portion and the bottom wall portion.

3. The height adjustable bathtub of claim 2, further comprising a drainage hole in the floor of the expandable basin and a removable plug positioned in the drainage hole.

4. The height adjustable bathtub of claim 1, wherein the extendable base comprises an inner member that slidingly engages an outer member, the inner member configured to lock at a plurality of positions within the outer member.

5. The height adjustable bathtub of claim 4, wherein the inner member has a pin configured to engage one of a plurality of locking slots of the outer member to lock the extendable base at a desired length.

6. The height adjustable bathtub of claim 1, wherein the extendable base comprises at least one extendable leg.

7. The height adjustable bathtub of claim 6, wherein the at least one extendable leg is configured to pivot about a connection point on the bottom surface of the housing such that the at least one extendable leg is movable between an active position and a storage position.

8. The height adjustable bathtub of claim 6, wherein the at least one extendable leg comprises an inner member that slidingly engages an outer member, the inner member having a pin configured to engage one of a plurality of locking slots of the outer member to lock the extendable leg at a desired length.

9. The height adjustable bathtub of claim 1, further comprising an opening in the housing positioned between the interior wall and the first longitudinal end.

10. The height adjustable bathtub of claim 9, further comprising a pocket positioned within the opening and secured to the housing.

11. The height adjustable bathtub of claim 1, further comprising a handlebar having a first end attached to the first lateral end of the housing and a second end attached to the second lateral end of the housing.

12. The height adjustable bathtub of claim 11, wherein each of the first end and the second end of the handlebar comprises a clip configured to snap-fit over a perimeter lip of the housing such that the handlebar is slidable along a length of the housing.

13. An expandable washbasin comprising:
a floor and;
a perimeter wall comprising:
a first end wall portion;
a second end wall portion; and
an expandable intermediate wall portion positioned between and secured to the first end wall portion and the second end wall portion.

14. The expandable washbasin of claim 13, further comprising a drainage hole in the floor and a removable plug positioned in the drainage hole.

15. The expandable washbasin of claim 13, wherein the expandable intermediate wall portion is formed of a flexible material.

16. The expandable washbasin of claim 15, wherein the second end wall portion is integrally formed with the floor.

17. The expandable washbasin of claim 15, wherein the perimeter wall is positioned within a cavity of a housing and the first end wall portion is secured to an interior wall of the housing defining the cavity.

18. The expandable washbasin of claim 17, further comprising an extendable base secured to a bottom surface of the housing.

19. The expandable washbasin of claim 18, wherein the extendable base comprises an inner member that slidingly engages an outer member, the inner member configured to lock at a plurality of positions within the outer member.

20.-25. (canceled)

26. The expandable washbasin of claim 13, wherein the expandable intermediate wall portion comprises a front wall portion and a rear wall portion, each of the front wall portion and the rear wall portion comprising at least two panels connected via a first hinge, a first of the at least two panels is connected to the first end wall portion via a second hinge and a second of the at least two panels is connected to the second end wall portion via a third hinge.

27.-31. (canceled)
